(19) United States
(12) Patent Application Publication
(10) Pub. No.: US 2018/0150805 A1
(43) Pub. Date: May 31, 2018

(54) Method and system for determining condition report of assets

(71) Applicants: Thomas Edward Shaver, Westerville, OH (US); Kittinai Jeerapaet, Tampa, FL (US)

(72) Inventors: Thomas Edward Shaver, Westerville, OH (US); Kittinai Jeerapaet, Tampa, FL (US)

(21) Appl. No.: 15/530,071

(22) Filed: Nov. 30, 2016

(51) Int. Cl. G06Q 10/00

(52) U.S. Cl. CPC G06Q 10/20

(57) ABSTRACT

The disclosed examples illustrate methods and systems for determining a condition report of one or more vehicles under inspection. The method includes acquiring a unique identifier associated with a vehicle using a hands-free wearable interactive device. The wearable interactive device is worn by a user for inspecting the vehicle. The method further includes acquiring a set of condition data corresponding to the vehicle using the wearable interactive device. The method further includes producing a condition report of the vehicle based at least on the set of condition data acquired using the wearable interactive device.

### TECHNICAL FIELD

The presently disclosed examples are related, in general, to inspection of assets. More particularly, the presently disclosed examples are related to methods and systems for determining a condition report of the assets under inspection.

### BACKGROUND

Inspection of various assets such as vehicles and other capital assets such as buildings, factory equipments, residential structures, civil structures, and mechanical systems (including military equipments) becomes an important aspect to ascertain the condition of the assets. Proper inspection is necessary to ascertain that the assets are in a good condition and do not suffer any major defects. Further, the inspection is desirable to determine whether the assets are damaged during use and/or to ascertain a current value of the assets. For example, a used vehicle might have suffered damage due to inappropriate use or an accident due to which the used vehicle may not be as valuable as compared to another vehicle that was appropriately used, well maintained, and was never subject to any accident. Also, one or more buyers of the used vehicle may be interested to obtain a complete inspection report of the used vehicle before purchase in order to minimize a risk.

Currently, the inspection of the assets may be performed using a portable handheld device such as, but not limited to a tablet. The portable handheld device may be accessed by an inspector for the inspection of the assets. For example, during an inspection of a vehicle by the inspector, the inspector may manually input information such as, but not limited to, a vehicle identification number, and/or damage parts of the vehicle, in the tablet. As an example, the tablet may be manufactured by Lenovo, Apple, or Micromax. Further, a model number of the tablet may be Lenovo Tab 3 Essential, Apple iPad Mini 2 tablet, or Micromax Canvas Tab P290 tablet. However, during a manual operation, the inspector may enter the information incorrectly, or may have forgotten to input the information in the tablet. Thus, such type of the manual operation for the inspection of the assets may be unreliable, and inefficient in order to ascertain the condition of the assets. Also, such type of the manual operation for the inspection of the assets may be a cumbersome task for the inspector. Therefore, there is a need for a method and system which may be reliable, efficient, and may operate in hands-free manner for the inspection of the assets.

### SUMMARY

It will be understood that this disclosure is not limited to the particular systems, and methods described, as there can be multiple possible examples of the present disclosure which are not expressly illustrated in the present disclosure. It is also to be understood that the terminology used in the description is for the purpose of describing the particular versions or examples only, and is not intended to limit the scope of the present disclosure.

According to examples illustrated herein, there is provided a method for determining a condition report of one or more vehicles under inspection. The method includes acquiring a unique identifier associated with a vehicle using a hands-free wearable interactive device. The wearable interactive device is worn by a user for inspecting the vehicle. The method further includes acquiring a set of condition data corresponding to the vehicle using the wearable interactive device. The method further includes producing a condition report of the vehicle based at least on the set of condition data acquired using the wearable interactive device.

According to examples illustrated herein, there is provided a method for determining a condition report of one or more capital assets under inspection. The method includes acquiring a unique identifier associated with an asset using a hands-free wearable interactive device. The wearable interactive device is worn by a user for inspecting the asset. The method further includes acquiring a set of condition data corresponding to the asset using the wearable interactive device. Further, the method includes producing a condition report of the asset based at least on the set of condition data acquired using the wearable interactive device.

According to examples illustrated herein, there is provided a system for determining a condition report of one or more vehicles under inspection. The system includes a wearable interactive device configured to acquire a unique identifier associated with a vehicle. The wearable interactive device is worn by a user for inspecting the vehicle. The wearable interactive device is configured to acquire a set of condition data corresponding to the vehicle. Further, the wearable interactive device is configured to produce a condition report of the vehicle based at least on the set of condition data corresponding to the vehicle.

Other systems, methods, features and advantages will be, or will become, apparent to one with skill in the art upon examination of the following figures and detailed description. It is intended that all such additional systems, methods, features and advantages be included within this description, be within the scope of the examples, and be protected by the following claims and be defined by the following claims. Further aspects and advantages are discussed below in conjunction with the description.

### BRIEF DESCRIPTION OF DRAWINGS

The accompanying drawings illustrate the various examples of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale. Non-limiting and non-exhaustive descriptions are described with reference to the following drawings. The components in the figures are not necessarily to scale, emphasis instead being placed upon illustrating principles.

Various examples will hereinafter be described in accordance with the appended drawings, which are provided to illustrate and not to limit the scope in any manner, wherein similar designations denote similar elements, and in which:

FIG. 1 is an exemplary vehicle under inspection using a wearable interactive device, in accordance with the concepts of the present disclosure;

FIG. 2 is a block diagram illustrating a system environment, in accordance with the concepts of the present disclosure;

FIG. 3 is a flow diagram illustrating the system environment, in accordance with the concepts of the present disclosure;

FIG. 4 is a perspective view of the wearable interactive device, in accordance with the concepts of the present disclosure;

FIG. 5 is a block diagram illustrating one or more components of the wearable interactive device, in accordance with the concepts of the present disclosure;

FIG. 6 is a flowchart illustrating a method for determining a condition report of the vehicle under inspection of FIG. 1, in accordance with the concepts of the present disclosure;

FIG. 7 is a flow diagram illustrating a system for determining the condition report of the vehicle under inspection of FIG. 1, in accordance with the concepts of the present disclosure;

FIG. 8 is a top view of another vehicle under inspection using the wearable interactive device along with a condition report, in accordance with the concepts of the present disclosure;

FIG. 9 is a flow diagram illustrating a system for determining a condition report of an asset under inspection, in accordance with the concepts of the present disclosure;

FIG. 10 is a flowchart illustrating a method for determining the condition report of the asset under inspection, in accordance with the concepts of the present disclosure;

FIG. 11 is the vehicle under inspection of FIG. 1 using the wearable interactive device by deploying a ground unmanned vehicle, in accordance with the concepts of the present disclosure;

FIG. 12 is an exemplary building under inspection using the wearable interactive device by deploying an airborne unmanned vehicle, in accordance with the concepts of the present disclosure; and

FIG. 13 is an exemplary ship under inspection using the wearable interactive device by deploying an underwater unmanned vehicle, in accordance with the concepts of the present disclosure.

### DETAILED DESCRIPTION

The present disclosure is best understood with reference to the detailed figures and description set forth herein. Various examples are discussed below with reference to the figures. However, those skilled in the art will readily appreciate that the detailed descriptions given herein with respect to the figures are simply for explanatory purposes as the methods and systems may extend beyond the described examples. For example, the teachings presented and the needs of a particular application may yield multiple alternative and suitable approaches to implement the functionality of any detail described herein. Therefore, any approach may extend beyond the particular implementation choices in the following examples described and shown.

Some examples of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of examples of the present invention, the preferred, systems and methods are now described.

References to “one example,” “at least one example,” “an example,” “for example,” and so on indicate that the example(s) may include a particular feature, structure, characteristic, property, element, or limitation but that not every example necessarily includes that particular feature, structure, characteristic, property, element, or limitation. Further, repeated use of the phrase “in an example” does not necessarily refer to the same example.

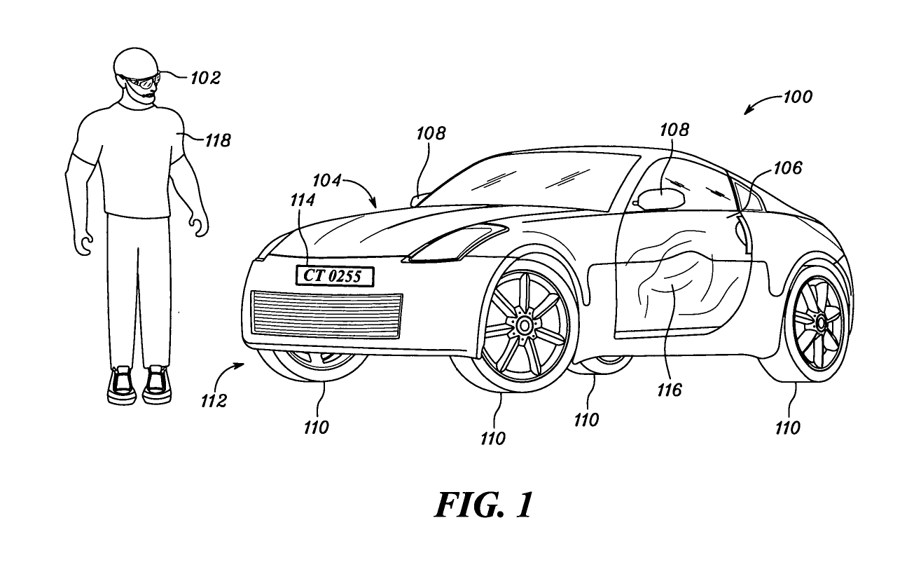

FIG. 1 is an exemplary vehicle 100 under inspection using a wearable interactive device 102, in accordance with the concepts of the present disclosure. The vehicle 100 includes an engine assembly 104, doors 106, mirrors 108, and tires 110. The vehicle 100 may include various other components such as, but not limited to, chassis, or rim. For the purpose of simplicity, the various other components are not labeled in FIG. 1.

The engine assembly 104 of the vehicle 100 may be disposed at a first end 112 of the vehicle 100. The engine assembly 104 may include an engine (not shown) that may be configured to provide power to the vehicle 100. Further, the vehicle 100 may include a unique identifier 114 associated with a particular vehicle 100 and may be permanently, semi-permanently, or temporarily attached to the vehicle 100. As an example, the identification number associated with the vehicle 100 is the license plate number “CT 0255”. In another example, the unique identifier 114 may include, but not limited to, a type of the vehicle 100, a model of the vehicle 100, and a make of the vehicle 100. Further, in another example, the unique identifier 114 may be a vehicle identification number (VIN) that may include codes indicating the make, model, year, etc. For cases, where the vehicle 100 is a part of a sale or an auction, the unique identifier 114 may be a temporary sign, placard, or a number painted on a windshield identifying an item, lot, or inventory number. It should be noted that the vehicle 100 may be monitored or inspected at a regular interval of time in order to ascertain the condition of the vehicle 100. The inspection of the vehicle 100 may be performed to determine whether the various components of the vehicle 100 may have suffered damage through an accident, or an in appropriate use of the vehicle 100. For example, the doors 106 of the vehicle 100 may suffer dents 116 or multiple scratches, through the accident. In another example, the mirrors 108 of the vehicle 100 may be broken. Such type of damages may be determined during the inspection of the vehicle 100.

Following Table 1 illustrates an exemplary list of the inspection of the various components of the vehicle 100 that may be performed by a user 118:

TABLE 1
Illustrative list of inspection items associated
with the various components of the vehicle 100

| Exterior | Interior | Chassis | Engine |
|---|---|---|---|
| Frame or structural | Significant damage to | Damage or wear to | Significant oil or |
| damage due to | seats, carpets, | exhaust system, | coolant leaks |
| collision | headliner, sun visors, | steering system, and | |
| | trim pieces, dash and | shock absorbers | |
| | console areas | | |
| Collision repairs that | Missing or broken | Transmission, | Serious mechanical |
| are below industry | items | differential or | problems indicated |
| standards | | power steering leaks | by abnormal noises, |
| | | | evidence of |
| | | | overheating, poor |
| | | | running condition or |
| | | | exhaust smoke |
| Significant dents, | Provides | Evidence of frame | Belts and hoses for |
| dings, and scratches | documentation of all | or structural damage | wear or need of |
| | accessories | due to collision | replacement |
| Missing or broken | Verifies proper | | Condition of fluids |
| components | operation of all | | |
| including glass and | factory equipment | | |
| mirrors | | | |
| Operation of exterior | | | Missing or damaged |
| lighting | | | components |
| Provides | | | |
| documentation on tire | | | |
| size, brand and | | | |
| amount of tread | | | |
| remaining on each | | | |
| tire | | | |
| Significant damage to | | | |
| wheels | | | |
| Abnormal wear and | | | |
| condition of tires | | | |

Referring to Table 1, the inspection of exterior components may include such items as dents, dings, and scratches, or broken components including glass and mirrors. Similarly, the inspection of interior components may include such items as significant damage to seats, carpets, headliner, sun visors, trim pieces, dash and console areas. On the other hand, the inspection of the chassis may include such items as damage or wear to exhaust system, steering system, and shock absorbers. Similarly, the inspection of the engine may include such items as significant oil or coolant leaks. It will be apparent to one skilled in the art that the above-mentioned Table 1 and the examples have been provided only for illustration purposes. The Table 1 may include some other information as well for the inspection of the vehicle 100, without departing from the scope of the disclosure.

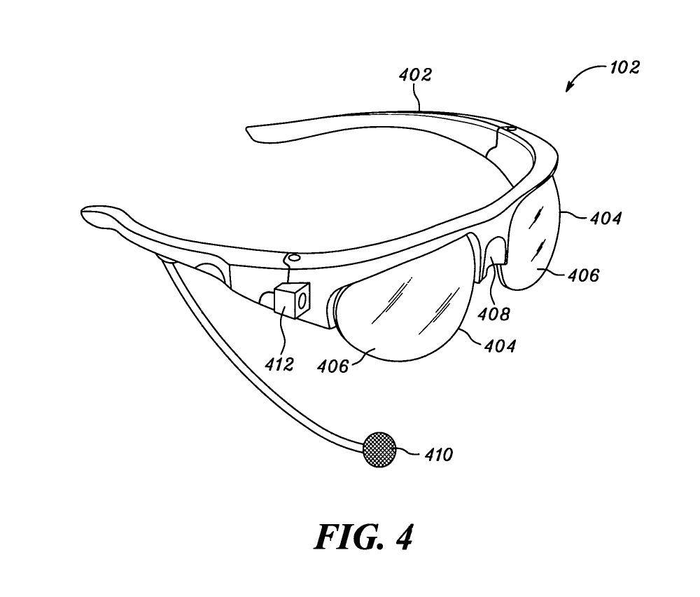

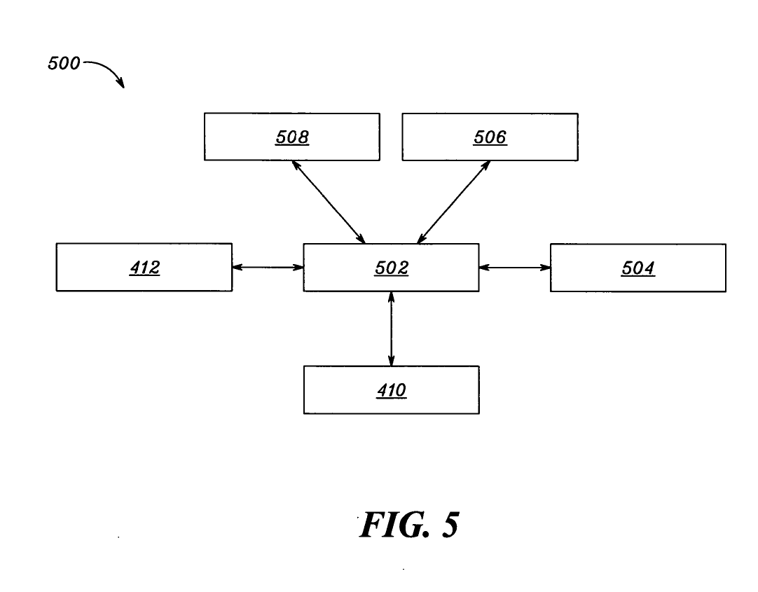

The inspection of the vehicle 100 may be performed using the wearable interactive device 102. The wearable interactive device 102 may be worn by the user 118. The wearable interactive device 102 may guide the user 118 in conducting the inspection of the vehicle 100. It should be noted that the user 118 may be physically present at a worksite (not shown) of the vehicle 100. In another example, the user 118 may travel to where the vehicle 100 may be located or the vehicle 100 may be driven or otherwise moved to where the user 118 may be located. The user 118 may be an inspector, or a technician. In an example, the wearable interactive device 102 may identify the user 118 associated with the inspection of the vehicle 100. Further, the wearable interactive device 102 may receive one or more inputs from the user 118. The one or more inputs may include at least one of a voice command, or a gesture command from the user 118. For example, the voice command may correspond to identification of the unique identifier 114 associated with the vehicle 100 under inspection. In another example, the voice command may correspond to the identification of the dents 116 on the doors 106 of the vehicle 100. The wearable interactive device 102 may be a head-mounted display, or a helmet-mounted display. The detailed description of the wearable interactive device 102 is described later in conjunction with FIGS. 4 and 5.

It should be noted that the above-mentioned vehicle 100 may be a new motor vehicle or a used motor vehicle. Examples of the motor vehicle may include a car, a truck, a motorcycle, a submarine, a boat, a ship, an aircraft, or other vehicle.

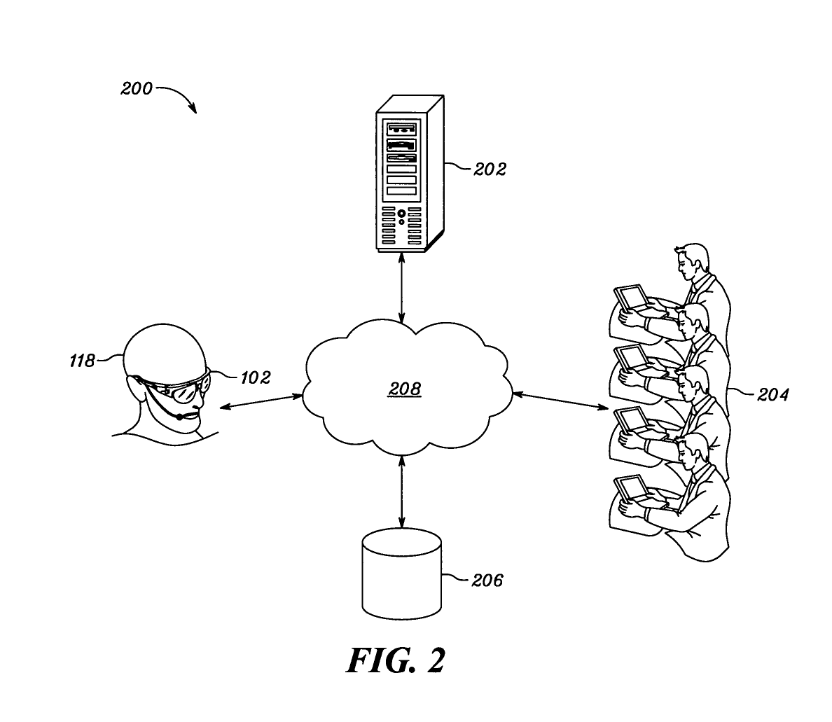

FIG. 2 is a block diagram illustrating a system environment 200, in accordance with the concepts of the present disclosure. The system environment 200 includes the wearable interactive device 102, a remote server 202, a first set of users 204, a database server 206, and a network 208. Various devices in the system environment 200 (e.g., the wearable interactive device 102, the remote server 202, the first set of users 204, and the database server 206) may be interconnected over the network 208. The system environment 200 is explained in conjunction with FIG. 1.

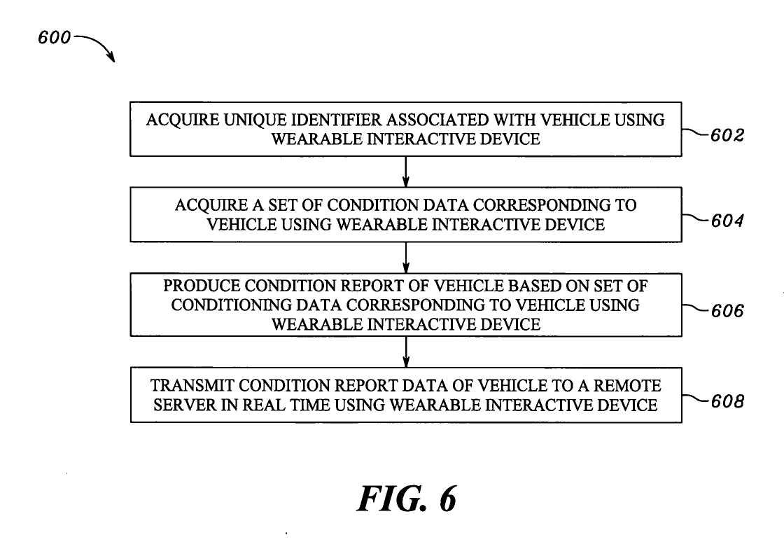

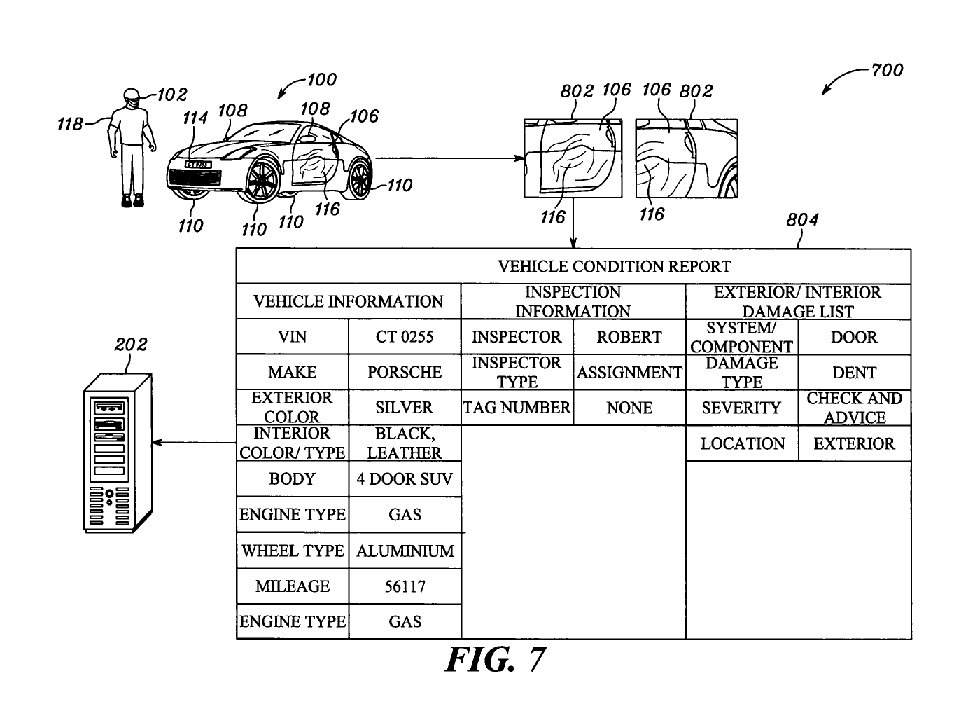

The wearable interactive device 102 may refer to a display device worn by the user 118. The wearable interactive device 102 may guide the user 118 for conducting the inspection of the vehicle 100. The wearable interactive device 102 may receive at least one of the voice command, and the gesture command, from the user 118. Based on the at least one of the voice command, and the gesture command, the wearable interactive device 102 may identify the unique identifier 114 associated with the vehicle 100. As discussed above, the unique identifier 114 may include, but not limited to, the identification number associated with the vehicle 100, the type of the vehicle 100, the model of the vehicle 100, and the make of the vehicle 100. Based on the identification of the unique identifier 114, the wearable interactive device 102 may acquire a set of condition data corresponding to the vehicle 100. Further, the wearable interactive device 102 may produce a condition report of the vehicle 100 based at least on the acquired set of condition data. Thereafter, the wearable interactive device 102 may transmit the condition report of the vehicle 100 to the remote server 202 in real time. The detailed description of the set of condition data and the condition report is described later in conjunction with FIGS. 6, and 7.

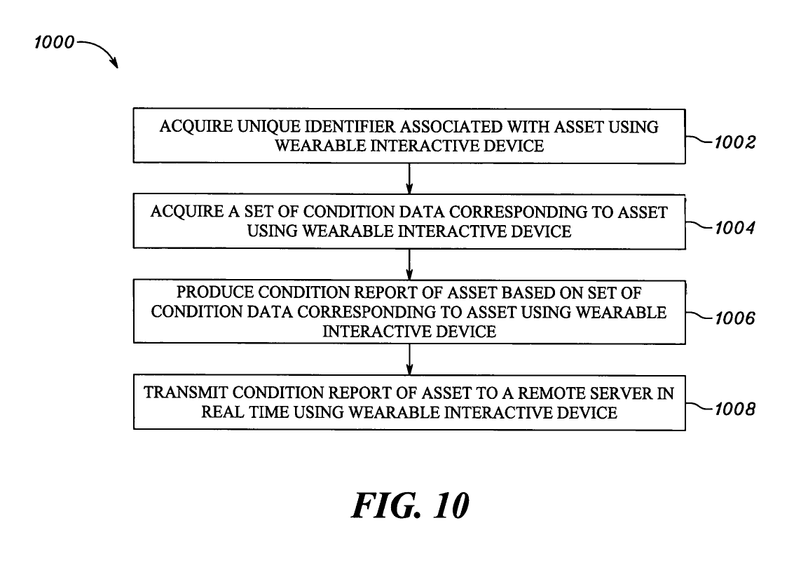

In an example, the wearable interactive device 102 may identify the user 118 associated with the inspection of the vehicle 100. It should be noted that the wearable interactive device 102 may identify at least one of a name of the user 118, and/or a designation of the user 118, associated with the inspection of the vehicle 100. In an example, the wearable interactive device 102 may stream the condition report of the vehicle 100 live to the first set of users 204. In another example, the wearable interactive device 102 may retrieve historical data corresponding to the vehicle 100, from the remote server 202. In an alternate example, the wearable interactive device 102 may deploy one or more unmanned vehicles for capturing the set of condition data corresponding to the vehicle 100. The one or more unmanned vehicles may include, but not limited to, an underwater unmanned vehicle, an airborne unmanned vehicle, and a ground unmanned vehicle. The detailed description of the deployment of the one or more unmanned vehicles for capturing the set of condition data corresponding to the vehicle 100 is described later in conjunction with FIGS. 10, 11, and 12.

The remote server 202 may refer to a server configured to receive the condition report of the vehicle 100 under inspection. The remote server 202 may communicate with the wearable interactive device 102 continuously in real time. In an example, the remote server 202 may receive a request from the wearable interactive device 102. The request may correspond to a historical data associated with the vehicle 100. Based on the received request, the remote server 202 may transmit the historical data corresponding to the vehicle 100 to the wearable interactive device 102. The historical data may include, but not limited to, an inspection report associated with one or more vehicles, one or more inspection rules as per industry standards, or a procedure for performing the inspection. In an example, the remote server 202 may receive the set of condition data corresponding to the vehicle 100 from the wearable interactive device 102.

In an alternate example, the remote server 202 may correspond to a streaming server that may be capable of delivering the condition report of the vehicle 100 live to the first set of users 204. It should be noted that the remote server 202 may transmit the condition report of the vehicle 100 using one or more network protocols such as TCP/IP, UDP, FTP, etc. The remote server 202 may be realized through various types of remote servers such as, but not limited to, Microsoft® SQL server, Java content server, .NET framework, Base4, Oracle, and My SQL.

The first set of users 204 may refer to one or more users that may receive live broadcasting of the condition report of the vehicle 100, from the wearable interactive device 102. The first set of users 204 may interact with the user 118 using one or more electronic devices. The one or more electronic devices may include, but are not limited to, laptop computers, desktop computers, personal digital assistants, wearable computers, or any other portable or non-portable electronic device. In an example, the one or more electronic devices may have a touch screen. The touch screen may display information for the first set of users 204 to see, and may allow the first set of users 204 to input information graphically, through gestures. For example, the first set of users 204 may use a stylus or a finger to actuate virtual buttons displayed on the touch screen, draw or otherwise may indicate graphical information, or perform other data input operations. It should be noted that the first set of users 204 may use the live broadcasting of the condition report for one or more purposes such as, but not limited to, bidding. The first set of users 204 may correspond to buyers, or bidders.

The database server 206 may refer to a server that may be configured to store the condition report of the vehicle 100. Further, the database server 206 may store information related to the inspection of the vehicle 100. The information related to the inspection of the vehicle 100 may include, but not limited to, one or more inspection schedules, and/or one or more inspection rules created by the user 118. The database server 206 may further store the set of condition data corresponding to the vehicle 100. In an example, the database server 206 may store a timestamp of the set of condition data corresponding to the vehicle 100. In an alternate example, the database server 206 may store the historical data corresponding to the vehicle 100. The database server 206 may be a SQL database server, an Oracle database server, or any other database server.

The network 208 corresponds to a medium through which content and messages flow between various devices of the system environment 200 (e.g., the wearable interactive device 102, the remote server 202, the first set of users 204, and the database server 206). Examples of the network 208 may include, but are not limited to, a Wireless Fidelity (Wi-Fi) network, a Wide Area Network (WAN), a Local Area Network (LAN), or a Metropolitan Area Network (MAN). Various devices in the system environment 200 may connect to the network 208 in accordance with various wired and wireless communication protocols such as Transmission Control Protocol and Internet Protocol (TCP/IP), User Datagram Protocol (UDP), and 2G, 3G, or 4G communication protocols.

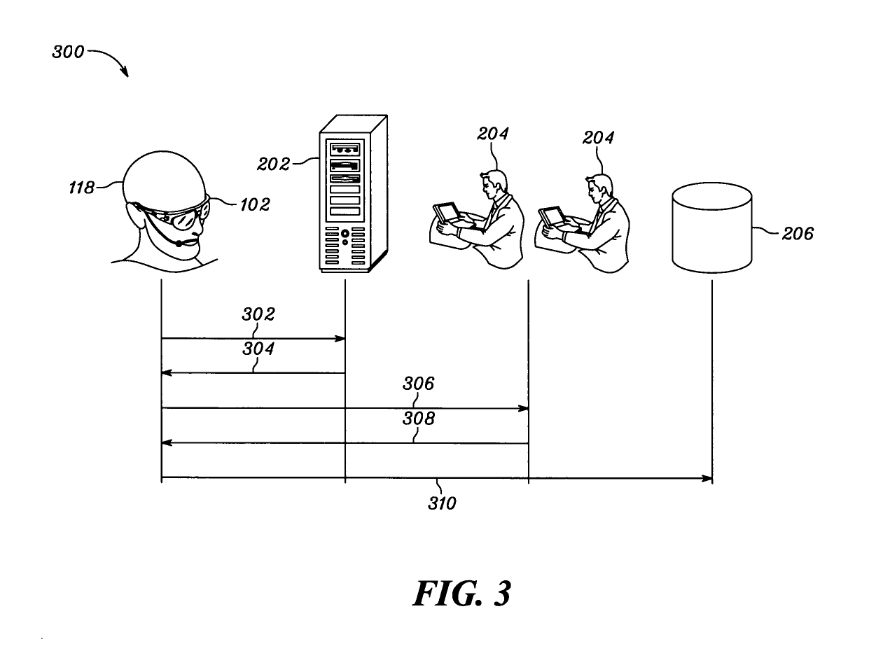

FIG. 3 is a flow diagram 300 illustrating the system environment 200, in accordance with the concepts of the present disclosure. The flow diagram 300 is described in conjunction with FIGS. 1 and 2.

At step 302, the user 118 may transmit the condition report of the vehicle 100 to the remote server 202, using the wearable interactive device 102. The condition report may include at least one of a value associated with the vehicle 100, and identification of damaged parts of the vehicle 100. At step 304, the remote server 202 may transmit an acknowledgement signal to the wearable interactive device 102 for the condition report of the vehicle 100. At step 306, the user 118 may stream the condition report of the vehicle 100 live to the first set of users 204, using the wearable interactive device 102. At step 308, the first set of users 204 may interact with the user 118 based on the received live streaming of the condition report of the vehicle 100. At step 310, the user 118 may store the condition report of the vehicle 100 in the database server 206, using the wearable interactive device 102.

FIG. 4 is a perspective view of the wearable interactive device 102, in accordance with the concepts of the present disclosure. The wearable interactive device 102 includes a frame 402, a pair of glasses 404, a pair of surfaces 406, a nasal ridge piece 408, an audio capturing device 410, and an image capturing device 412. FIG. 4 is described in conjunction with FIGS. 1 and 2.

The frame 402 may be adapted to be worn by the user 118, and supported by nose and ears of the user 118. In an alternate example, a strap (not shown) may be used to hold the frame 402 of the wearable interactive device 102 in a fixed position with respect to eyes of the user 118. The frame 402 may further support the pair of glasses 404. It should be noted that the pair of glasses 404 may have the pair of surfaces 406. The pair of surfaces 406 may be a reflective optical surface. The reflective optical surface may be a free space, ultra-wide angle, reflective optical surface i.e., FS/UWA/RO surface. The reflective optical surface may be of a curved shape. Further, the pair of surfaces 406 may be a purely reflective or may include both reflective and transmissive properties. It should be noted that the pair of surfaces 406 may completely surround the eyes of the user 118. The pair of surfaces 406 may be separately supported by the frame 402 and/or the nasal ridge piece 408.

The nasal ridge piece 408 may be a vertical bar or a wall which provides a separation between the pair of surfaces 406. In an example, the nasal ridge piece 408 may include two reflectors (not shown). The reflectors may allow the user 118 to see imagery as the user 118 may turn the eyes nasally, either to left or to right.

The audio capturing device 410 may be configured to capture one or more audio inputs of the user 118. The audio inputs may include, but not limited to, one or more voice commands of the user 118. The one or more voice commands may include one or more instructions such as, but not limited to, the identification of the unique identifier 114 associated with the vehicle 100, and/or to identify the damage parts of the vehicle 100. In an example, the audio capturing device 410 may be utilized by the user 118 to interact with the first set of users 204. In an alternate example, the audio capturing device 410 may be utilized by the user 118 for deploying the one or more unmanned vehicles. The audio capturing device 410 may be a microphone. It should be noted that the audio capturing device 410 may be some other device as well, without departing from the scope of the disclosure.

The image capturing device 412 may be configured to capture the set of condition data corresponding to the vehicle 100 under inspection. The set of condition data may include, but not limited to, one or more still images of the vehicle 100. In an example, the image capturing device 412 may act as a video capturing device, and thus may record one or more videos related to the inspection of the vehicle 100. The one or more videos may display the damage parts of the vehicle 100 under inspection. In an alternate example, the image capturing device 412 may record the timestamp of the set of condition data corresponding to the vehicle 100. The image capturing device 412 may be a digital camera, or any other imaging device.

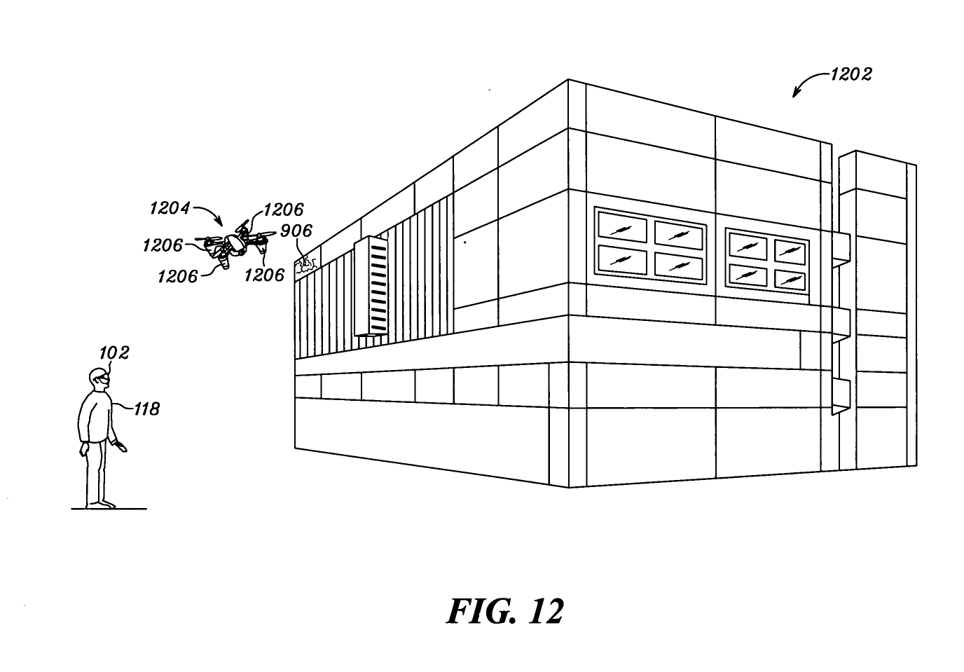

It should be noted that the wearable interactive device 102 may act as a viewfinder. The viewfinder may allow the user 118 to see through the water. For example, the wearable interactive device 102 for one or more underwater unmanned vehicles, may act as the viewfinder to allow the user 118 to see through the water. The detailed description of the viewfinder is described later in conjunction with FIG. 12. The wearable interactive device 102 may be a head-mounted display, and a head-mounted camera. In an example, the wearable interactive device 102 may be a helmet-mounted display as well, without departing from the scope of the disclosure.

FIG. 5 is a block diagram 500 illustrating one or more components of the wearable interactive device 102, in accordance with the concepts of the present disclosure. The block diagram 500 is described in conjunction with FIGS. 1, 2, 3, and 4.

Referring to FIGS. 4 and 5, the wearable interactive device 102 includes the audio capturing device 410, the image capturing device 412, a microprocessor 502, a memory 504, a transceiver 506, and a display device 508. The microprocessor 502 is coupled to the audio capturing device 410, the image capturing device 412, the memory 504, the transceiver 506, and the display device 508.

The microprocessor 502 includes suitable logic, circuitry, and/or interfaces that are operable to execute one or more instructions stored in the memory 504 to perform predetermined operations. The microprocessor 502 may be implemented using one or more microprocessor technologies known in the art. Examples of the microprocessor 502 include, but are not limited to, an x86 microprocessor, an ARM microprocessor, a Reduced Instruction Set Computing (RISC) microprocessor, an Application Specific Integrated Circuit (ASIC) microprocessor, a Complex Instruction Set Computing (CISC) microprocessor, or any other microprocessor.

The memory 504 stores a set of instructions and data. Some of the commonly known memory implementations include, but are not limited to, a random access memory (RAM), a read only memory (ROM), a hard disk drive (HDD), and a secure digital (SD) card. Further, the memory 504 includes the condition report of the vehicle 100 that is executable by the microprocessor 502 to perform specific operations. The memory 504 further includes the set of condition data corresponding to the vehicle 100, captured by the wearable interactive device 102.

The transceiver 506 transmits and receives messages and data to/from various components of the system environment 200 (e.g., the wearable interactive device 102, the remote server 202, the first set of users 204, and the database server 206) over the network 208. Examples of the transceiver 506 may include, but are not limited to, an antenna, an Ethernet port, a USB port, or any other port that can be configured to receive and transmit data. The transceiver 506 transmits and receives data/messages in accordance with the various communication protocols, such as, TCP/IP, UDP, and 2G, 3G, or 4G communication protocols.

The display device 508 may comprise suitable logic, circuitry, interfaces, and/or code that may be operable to render a user interface. In an example, the display device 508 may be realized through several known technologies, such as, Cathode Ray Tube (CRT) based display, Liquid Crystal Display (LCD), Light Emitting Diode (LED) based display, Organic LED display technology, and Retina display technology. The display device 508 may display the unique identifier 114 associated with the vehicle 100. The display device 508 may display the condition report of the vehicle 100. Further, the display device 508 may display the set of condition data of the vehicle 100. In an example, the display device 508 may display the condition report live to the first set of users 204. In a scenario, the display device 508 may be a touch screen that enables the user 118 to provide input. In an example, the touch screen may correspond to at least one of a resistive touch screen, capacitive touch screen, or a thermal touch screen. In an example, the display device 508 may receive input through a virtual keypad, a gesture, and/or a touch based input.

It will be apparent to one skilled in the art that the above-mentioned various components of the wearable interactive device 102 have been provided only for illustration purposes. The wearable interactive device 102 may include some other components as well, without departing from the scope of the disclosure.

FIG. 6 is a flowchart illustrating a method 600 for determining the condition report of the vehicle 100 under inspection, in accordance with the concepts of the present disclosure. The method 600 is described in conjunction with FIGS. 1, 2, 3, 4, and 5.

At step 602, the unique identifier 114 associated with the vehicle 100 is acquired. The wearable interactive device 102 may acquire the unique identifier 114 associated with the vehicle 100 under inspection. The unique identifier 114 may include at least one of the identification number associated with the vehicle 100, the type of the vehicle 100, the model of the vehicle 100, and the make of the vehicle 100. In an example, the wearable interactive device 102 may deploy one or more unmanned vehicles (not shown) for identifying the unique identifier 114 associated with the vehicle 100. The one or more unmanned vehicles are described later in conjunction with FIG. 10. In another example, the wearable interactive device 102 may receive at least one of the voice command or the gesture command from the user 118 for the identification of the unique identifier 114. In another example, the wearable interactive device 102 may decode the identification number associated with the vehicle 100 to determine the make of the vehicle 100. For example, as shown in FIG. 1, the identification number associated with the vehicle 100 is “CT 0255”, and the make of the vehicle 100 is “PORSCHE”.

At step 604, the set of condition data corresponding to the vehicle 100 is acquired. The wearable interactive device 102 may acquire the set of condition data corresponding to the vehicle 100. As discussed above, the set of condition data includes at least one of still images of the vehicle 100, video files of the vehicle 100, and audio recordings corresponding to the vehicle 100. The set of condition data may indicate one or more locations of dents, scratches, or any other damages, to the vehicle 100. In an example, the wearable interactive device 102 may capture the set of condition data based at least on the voice command and/or the gesture command from the user 118. For example, the wearable interactive device 102 may capture broken images of the mirrors 108 based on the voice command from the user 118. In an example, the wearable interactive device 102 may deploy the one or more unmanned vehicles for capturing the set of condition data corresponding to the vehicle 100. The detailed description of the one or more unmanned vehicles is described later in conjunction with FIGS. 10, 11, and 12.

In an example, the wearable interactive device 102 may provide the timestamp of the set of condition data corresponding to the vehicle 100. It should be noted that the wearable interactive device 102 may capture the timestamp of the damage part of the vehicle 100. For example, the wearable interactive device 102 may record a video of the dents 116 on the doors 106 that may provide the user 118 a particular timestamp corresponding to the dents 116 on the doors 106. It will be apparent to one skilled in the art that the above-mentioned examples of the set of condition data have been provided only for illustrations purposes, without departing from the scope of the disclosure.

At step 606, the condition report of the vehicle 100 is produced. The wearable interactive device 102 may produce the condition report of the vehicle 100 based at least on the acquired set of condition data, as discussed in step 604. The condition report may include at least one of a value associated with the vehicle 100, information associated with the vehicle 100, information associated with the user 118, and/or the damage parts of the vehicle 100. It should be noted that the value may be associated with the various components of the vehicle 100. The value associated with the vehicle 100 may indicate whether a condition of the vehicle 100 is “Average”, “Below Average”, or “Good”. For example, if the vehicle 100 corresponds to a used vehicle which has multiple dents or scratches, then the value associated with the vehicle 100 may be low i.e., “Below Average”. In another example, if the vehicle 100 corresponds to a new vehicle, then the value associated with the vehicle 100 may be high i.e., “Good”. The detailed description of the condition report is described later in conjunction with FIG. 7.

At step 608, the condition report of the vehicle 100 is transmitted. The wearable interactive device 102 may transmit the condition report of the vehicle 100 to the remote server 202 in real time.

FIG. 7 is a flow diagram illustrating a system 700 for determining the condition report of the vehicle 100 under inspection of FIG. 1, in accordance with the concepts of the present disclosure. The system 700 is described in conjunction with FIGS. 1, 2, 3, 4, 5, and 6.

As shown in FIG. 7, the wearable interactive device 102 may be worn by the user 118 for inspecting the vehicle 100. During the inspection of the vehicle 100, the wearable interactive device 102 may identify the unique identifier 114 associated with the vehicle 100. As an example, the unique identifier 114 is “CT 0255”. Based on the identification of the unique identifier 114, the wearable interactive device 102 may acquire a set of condition data (as shown by 702) corresponding to the vehicle 100. The set of condition data (as shown by 702) may indicate one or more images of the dents 116 on the doors 106 of the vehicle 100. Based on the acquired set of condition data (as shown by 702), the wearable interactive device 102 may produce a condition report (as shown by 704) of the vehicle 100. The condition report (as shown by 704) of the vehicle 100 may include, but not limited to, information associated with the vehicle 100, an inspection information, and exterior/interior damage list. The information associated with the vehicle 100 may include, but not limited to, VIN is “CT 0255”, a make of the vehicle 100 is “PORSCHE”, and an exterior color of the vehicle 100 is “SILVER”. Thereafter, the wearable interactive device 102 may transmit the condition report (as shown by 704) of the vehicle 100 to the remote server 202 in real time.

It will be apparent to one skilled in the art that the scope of the disclosure is not limited to above disclosed inspection of the vehicle 100 using the wearable interactive device 102. In an example, the inspection of one or more assets such as, but not limited to, buildings, houses, or factories, may be performed using the wearable interactive device 102 to detect flaws, defects, or damages, without departing from the scope of the disclosure.

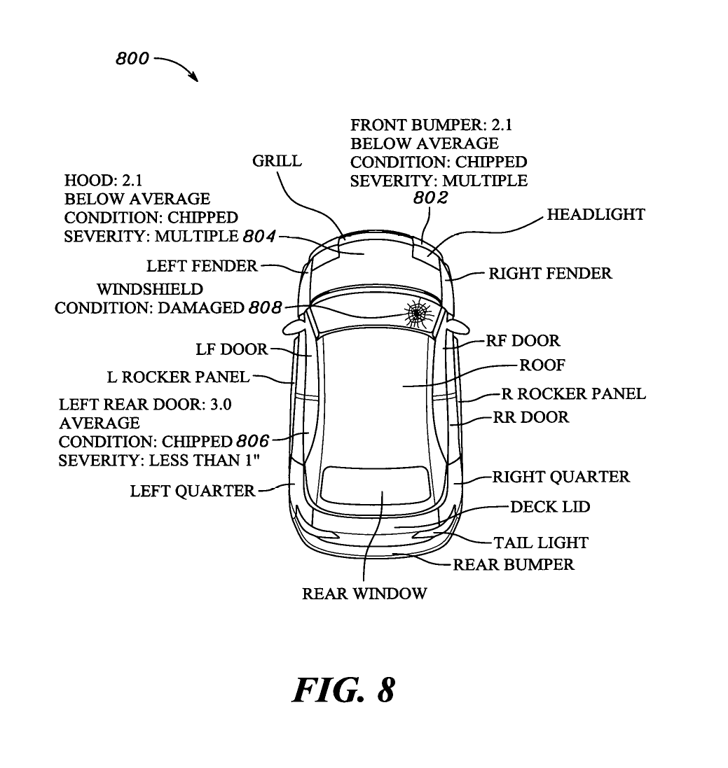

FIG. 8 is a top view of another vehicle 800 under inspection using the wearable interactive device 102 along with a condition report, in accordance with the concepts of the present disclosure. The vehicle 800 under inspection is described in conjunction with FIGS. 1, 2, 3, 4, 5, 6 and 7.

The vehicle 800 includes various exterior components such as, but not limited to, a front bumper, a right fender, a RF door (i.e., a right front door), a roof, a R rocker panel (i.e., a right rocker panel), a RR door (i.e., a right rear door), a right quarter, a deck lid, a tail light, a rear bumper, a rear window, a left quarter, a LR door (i.e., a left rear door), a L rocker panel, a LF door (i.e., a left front door), a windshield, a left fender, a grill, a hood, and a headlight. It will be apparent one skilled in the art that the exterior components of the vehicle 800 under inspection have been provided only for illustration purposes, without departing from the scope of the disclosure.

As shown in FIG. 8, the exterior components of the vehicle 800 may be inspected by the user 118 using the wearable interactive device 102. Based on the inspection of the vehicle 800, the wearable interactive device 102 may produce the condition report of the vehicle 800. The condition report may indicate that a front bumper 802, a hood 804, a left rear door 806, and a windshield 808, may suffer multiple damages. Following Table 2 illustrates the condition report of the vehicle 800:

TABLE 2
Illustration of the condition report

| Exterior | | | |
|---|---|---|---|
| Components | Value | Condition | Severity |
| Front bumper | 2.1 (Below Average) | Chipped | Multiple |
| Hood | 2.1 (Below Average) | Chipped | Multiple |
| Left rear door | 3.0 (Average) | Chipped | Less than 1 inches |
| Windshield | 1 (Below Average) | Damaged | |

Referring to Table 2, a value associated with the front bumper 802 is 2.1 i.e., below average, a condition is “chipped”, and a severity is “Multiple”. In another example, a value associated with the hood 804 is 2.1 i.e., below average, a condition is “chipped”, and a severity is “Multiple”. Further, in another example, a value associated with the left rear door 806 is 3 i.e., average, a condition is “chipped”, and a severity is “less than 1 inches”. It should be noted that the above-mentioned Table 2 has been provided only for illustration purposes. Table 2 may include some other information as well, without departing from the scope of the disclosure.

It will be apparent to one skilled in the art that the above-mentioned inspection of the exterior components of the vehicle 100 has been provided only for illustration purposes. In an example, the inspection of one or more interior components such as, but not limited to, a steering wheel, a console, or seats, without departing from the scope of the disclosure.

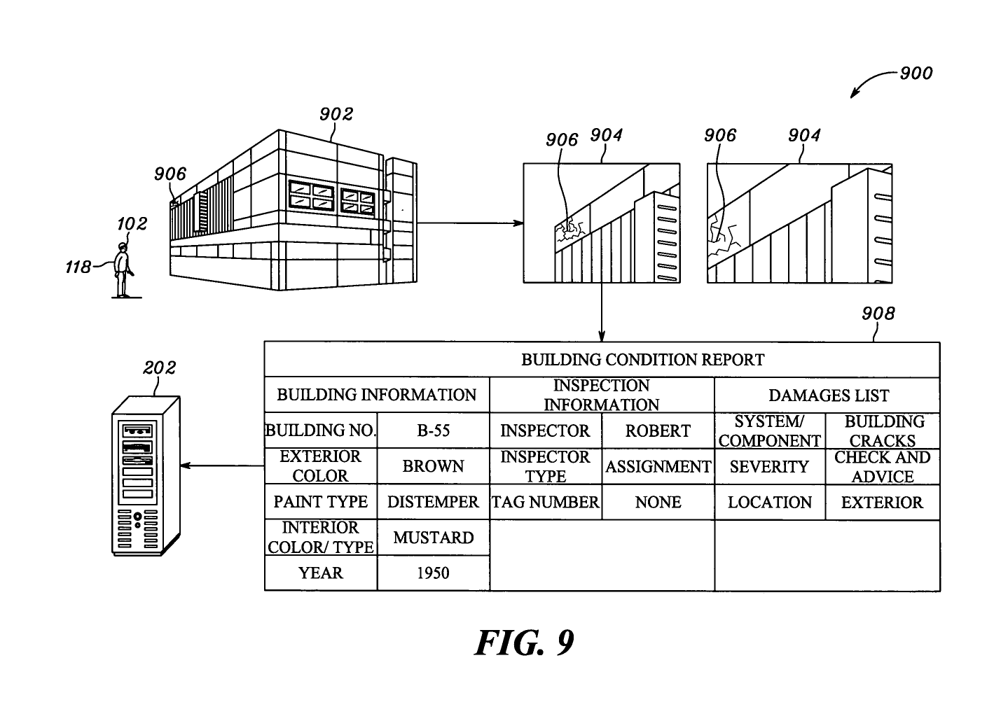

FIG. 9 is a flow diagram illustrating a system 900 for determining a condition report of an asset 902 under inspection, in accordance with the concepts of the present disclosure. The system 900 is described in conjunction with FIGS. 2, 3, 4, and 5.

As shown in FIG. 9, the wearable interactive device 102 may be worn by the user 118 for inspecting the asset 902. It should be noted that the asset 902 is a building. In an example, the asset 902 may be a factory, a house, a residential structure, a civil structure, and a mechanical system, without departing from the scope of the disclosure. During the inspection of the asset 902, the wearable interactive device 102 may identify a unique identifier associated with the asset 902. The unique identifier associated with the asset 902 may include at least one of an identification number associated with the asset 902, and/or damage list of the asset 902. For example, a building number is “B-55”. Based on the identification of the unique identifier, the wearable interactive device 102 may acquire a set of condition data (as shown by 904) corresponding to the asset 902. As an example, the set of condition data (as shown by 904) may indicate one or more images of cracks 906 in the building. The detailed description of the set of condition data corresponding to the asset 902 is described later in conjunction with FIG. 9.

Based on the acquired set of condition data (as shown by 904), the wearable interactive device 102 may determine a condition report (as shown by 908) of the asset 902. The condition report (as shown by 908) may include at least one of a value associated with the asset 902, information associated with the asset 902, information associated with the user 118, and/or the damage parts of the asset 902. As an example, the condition report (as shown by 908) of the building may include, but not limited to, building information, an inspection information, and damages list. The building information may include, but not limited to, a building number is “B-55”, an exterior color is “BROWN”, and a paint type is “DISTEMPER”. Thereafter, the wearable interactive device 102 may transmit the condition report (as shown by 908) of the asset 902 to the remote server 202 in real time.

FIG. 10 is a flowchart illustrating a method 1000 for determining the condition report of the asset 902 under inspection, in accordance with the concepts of the present disclosure. The method 1000 is described in conjunction with FIGS. 2, 3, 4, 5, and 9.

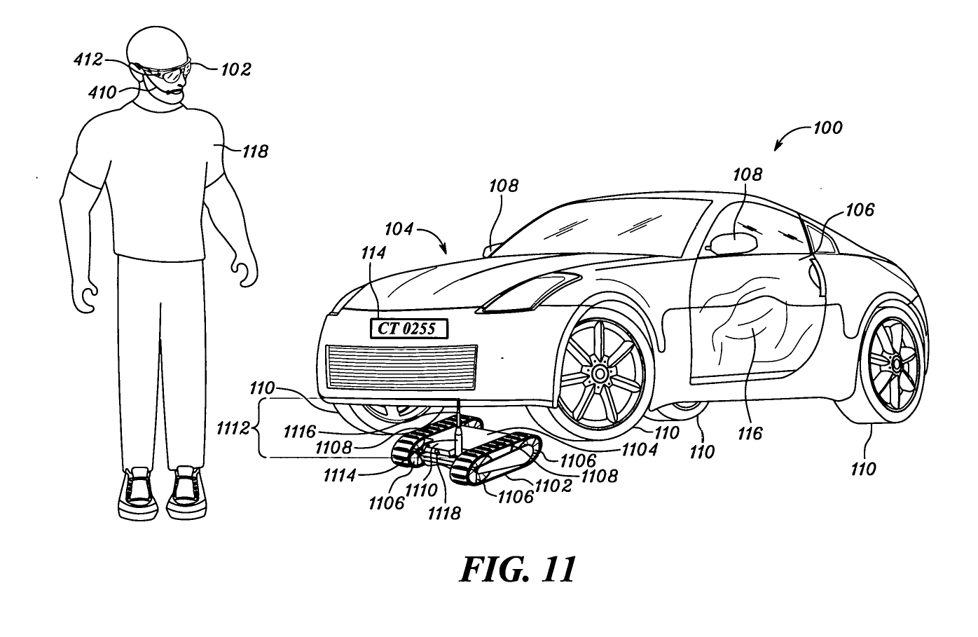

At step 1002, the unique identifier associated with the asset 902 is acquired. The wearable interactive device 102 may acquire the unique identifier associated with the asset 902 under inspection. In an example, the wearable interactive device 102 may deploy one or more unmanned vehicles (not shown) for identifying the unique identifier associated with the asset 902. The one or more unmanned vehicles are described later in conjunction with FIGS. 11, and 12. In another example, the wearable interactive device 102 may receive at least one of the voice command or the gesture command from the user 118 for the identification of the unique identifier associated with the asset 902.

At step 1004, a set of condition data corresponding to the asset 902 is acquired. The wearable interactive device 102 may acquire the set of condition data corresponding to the asset 902. As discussed above, the set of condition data may include at least one of an image of the asset 902, a video of the asset 902, and an audio recording corresponding to the asset 902. The set of condition data may indicate one or more locations of cracks or damages in the asset 902. In an example, the wearable interactive device 102 may capture the set of condition data based at least on a voice command and/or a gesture command from the user 118. In an example, the wearable interactive device 102 may deploy one or more unmanned vehicles for capturing the set of condition data corresponding to the vehicle 100. The detailed description of the one or more unmanned vehicles is described later in conjunction with FIGS. 11, and 12.

In an example, the wearable interactive device 102 may provide the timestamp of the set of condition data corresponding to the asset 902. It should be noted that the wearable interactive device 102 may capture the timestamp of the damage parts of the asset 902. For example, the wearable interactive device 102 may record a video of the cracks 906 in the building that may provide the user 118 a particular timestamp corresponding to the cracks 906. It will be apparent to one skilled in the art that the above-mentioned examples of the set of condition data have been provided only for illustrations purposes, without departing from the scope of the disclosure.

At step 1006, a condition report of the asset 902 is produced. The wearable interactive device 102 may produce the condition report of the asset 902 based at least on the acquired set of condition data, as discussed in step 1004. As discussed above, the condition report may include at least one of the value associated with the asset 902, the information associated with the asset 902, the information associated with the user 118, and/or the damage parts of the asset 902. For example, if the asset 902 corresponds to an old building which has multiple cracks, then the value associated with the asset 902 may be low. In another example, if the asset 902 corresponds to a new building, then the value associated with the asset 902 may be high.

At step 1008, the condition report of the asset 902 is transmitted. The wearable interactive device 102 may transmit the condition report of the asset 902 to the remote server 202 in real time.

FIG. 11 is the vehicle 100 under inspection using the wearable interactive device 102 by deploying a ground unmanned vehicle 1102, in accordance with the concepts of the present disclosure. The vehicle 100 under inspection using the wearable interactive device 102 by deploying the ground unmanned vehicle 1102 is described in conjunction with FIGS. 1, 2, 3, 4, 5, 6, and 7.

The ground unmanned vehicle 1102 includes a housing 1104 having wheels 1106 and tracks 1108. The housing 1104 may include, but not limited to, an aluminum or other durable materials such as, but not limited to, plastics. Further, the housing 1104 having a surface 1110 (i.e., a top surface) that may lie slightly below a surface of the tracks 1108. It should be noted that the surface 1110 is substantially flat. Further, the ground unmanned vehicle 1102 may include an antenna assembly 1112 that may extend upwardly from the surface 1110 of the housing 1104. The antenna assembly 1112 may include an antenna mast 1114 and an antenna 1116. The antenna mast 1114 may be bendable and resilient. In an example, the antenna mast 1114 may be folded over the housing 1104 for compact storage. Further, a height of the antenna assembly 1112 may be selected to allow a desired communication range, for example, 200 meter to 300 meter range. Further, the ground unmanned vehicle 1102 may include one or more cameras 1118 that may be provided with an IR LED (Infrared LED) for low-light operation.

It should be noted that a size of the ground unmanned vehicle 1102 may be configured to accommodate the size of the antenna 1116. For example, the ground unmanned vehicle 1102 may be sized such that the antenna 1116 may rest on and be supported on the surface 1110 of the housing 1104. It will be apparent to one skilled in the art that the above-mentioned various components of the ground unmanned vehicle 1102 have been provided only for illustration purposes. The ground unmanned vehicle 1102 may include some other components as well, without departing from the scope of the disclosure.

As shown in FIG. 11, the wearable interactive device 102 may be worn by the user 118 for inspecting the vehicle 100. During the inspection of the vehicle 100, the wearable interactive device 102 may identify the unique identifier 114 associated with the vehicle 100. In an example, the wearable interactive device 102 may deploy the ground unmanned vehicle 1102 for identifying the unique identifier 114 associated with the vehicle 100. Based on the identification of the unique identifier 114, the wearable interactive device 102 may acquire the set of condition data corresponding to the vehicle 100. It should be noted that the wearable interactive device 102 may deploy the ground unmanned vehicle 1102 for capturing the set of condition data corresponding to the vehicle 100. For example, the ground unmanned vehicle 1102 may be deployed to drive under the vehicle 100 for monitoring various components such as, but not limited to, the chassis of the vehicle 100. In an example, the user 118 may give the at least one of the voice command, or the gesture command using the wearable interactive device 102 for controlling the ground unmanned vehicle 1102. Based at least on the acquired set of condition data, the wearable interactive device 102 may produce the condition report of the vehicle 100. Thereafter, the wearable interactive device 102 may transmit the condition report of the asset 902 to the remote server 202 in real time.

It will be apparent to one skilled in the art that the ground unmanned vehicle 1102 mentioned above has been provided only for illustration purposes. The wearable interactive device 102 may deploy some other ground unmanned vehicles having a different design or structure as well, without departing from the scope of the disclosure.

FIG. 12 is an exemplary building 1202 under inspection using the wearable interactive device 102 by deploying an airborne unmanned vehicle 1204, in accordance with the concepts of the present disclosure. The building 1202 under inspection using the wearable interactive device 102 by deploying the airborne unmanned vehicle 1204 is described in conjunction with FIGS. 2, 3, 4, 5, 9, and 10.

The airborne unmanned vehicle 1204 may include wings 1206 for enabling the airborne unmanned vehicle 1204 to fly. The airborne unmanned vehicle 1204 may further include an antenna (not shown) for enabling the communication with the wearable interactive device 102. Further, the airborne unmanned vehicle 1204 may include one or more cameras (not shown) that may be provided with an IR LED (Infrared LED) for low-light operation. It will be apparent to one skilled in the art that the airborne unmanned vehicle 1204 may include some other components as well, without departing from the scope of the disclosure.

As shown in FIG. 12, the wearable interactive device 102 may be worn by the user 118 for inspecting the building 1202. During the inspection of the building 1202, the wearable interactive device 102 may identify the unique identifier associated with the building 1202. In an example, the wearable interactive device 102 may deploy the airborne unmanned vehicle 1204 for identifying the unique identifier associated with the building 1202. Based on the identification of the unique identifier, the wearable interactive device 102 may acquire the set of condition data corresponding to the building 1202. It should be noted that the wearable interactive device 102 may deploy the airborne unmanned vehicle 1204 for capturing the set of condition data associated with the building 1202. For example, the airborne unmanned vehicle 1204 may be deployed for recording the damage parts of the building 1202 such as, but not limited to, the cracks 906 in the building 1202. In an example, the user 118 may give the at least one of the voice command, or the gesture command using the wearable interactive device 102 for controlling the airborne unmanned vehicle 1204. Based at least on the acquired set of condition data, the wearable interactive device 102 may produce the condition report of the building 1202. Thereafter, the wearable interactive device 102 may transmit the condition report of the building 1202 to the remote server 202 in real time.

It will be apparent to one skilled in the art that the airborne unmanned vehicle 1204 mentioned above has been provided only for illustration purposes. The wearable interactive device 102 may deploy some other airborne unmanned vehicles having a different design or structure, as well, without departing from the scope of the disclosure.

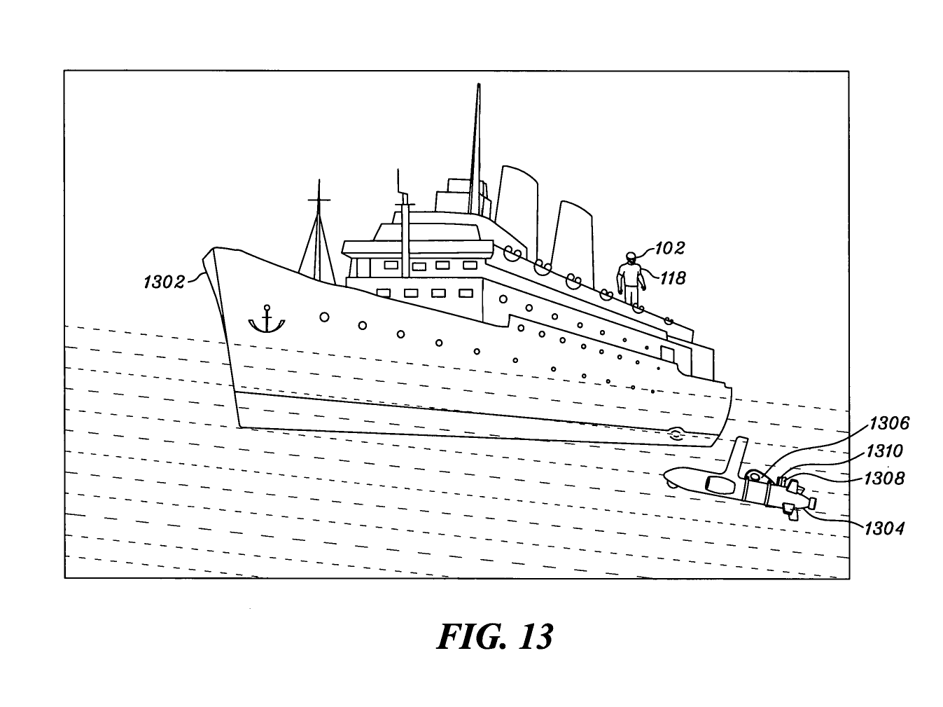

FIG. 13 is an exemplary ship 1302 under inspection using the wearable interactive device 102 by deploying an underwater unmanned vehicle 1304, in accordance with the concepts of the present disclosure. The ship 1302 under inspection using the wearable interactive device 102 by deploying the underwater unmanned vehicle 1304 is described in conjunction with FIGS. 2, 3, 4, 5, 9, and 10.

The underwater unmanned vehicle 1304 may include a lift bail 1306, an emergency light 1308, and a communication module 1310. The emergency light 1308 may be used to illuminate light in case of emergency. On the other hand, the communication module 1310 may be used for the communication with the wearable interactive device 102. The communication module 1310 may be a GPS, WIFI, or IRIDIUM medium. Further, the underwater unmanned vehicle 1304 may include one or more cameras (not shown) that may be provided with an IR LED (Infrared LED) for low-light operation. It will be apparent to one skilled in the art that the underwater unmanned vehicle 1304 may include some other components as well, without departing from the scope of the disclosure.

As shown in FIG. 13, the wearable interactive device 102 may be worn by the user 118 for inspecting the ship 1302. During the inspection of the ship 1302, the wearable interactive device 102 may identify a unique identifier associated with the ship 1302. In an example, the wearable interactive device 102 may deploy the underwater unmanned vehicle 1304 for identifying the unique identifier associated with the ship 1302. The unique identifier may include, but not limited to, an identification number associated with the ship 1302, or a model number of the ship 1302. In an example, the wearable interactive device 102 may deploy the underwater unmanned vehicle 1304 for identifying the unique identifier associated with the ship 1302. Based on the identification of the unique identifier, the wearable interactive device 102 may acquire the set of condition data corresponding to the ship 1302. The wearable interactive device 102 may deploy the underwater unmanned vehicle 1304 for capturing the set of condition data associated with the ship 1302. It should be noted that the wearable interactive device 102 may act as the viewfinder for the underwater unmanned vehicle 1304. The viewfinder may allow the user 118 to see through the water from the ship 1302. For example, the underwater unmanned vehicle 1304 may be deployed to record the damage parts such as, but not limited to, bottom hole dents, of the ship 1302.

In an example, the user 118 may give the at least one of the voice command, or the gesture command using the wearable interactive device 102 for controlling the underwater unmanned vehicle 1304. Based at least on the acquired set of condition data, the wearable interactive device 102 may produce the condition report of the ship 1302. Thereafter, the wearable interactive device 102 may transmit the condition report of the ship 1302 to the remote server 202 in real time.

It will be apparent to one skilled in the art that the underwater unmanned vehicle 1304 mentioned above has been provided only for illustration purposes. The wearable interactive device 102 may deploy some other underwater unmanned vehicles having a different design or structure, as well, without departing from the scope of the disclosure.

It should be noted that the above-mentioned inspection of the vehicle 100 and the asset 902 using the wearable interactive device 102, have been provided only for illustration purposes. In an example, the inspection of goods or services may be possible using the wearable interactive device 102, without departing from the scope of the disclosure.

The disclosed examples encompass numerous advantages. Various examples of methods and systems for determining a condition report of one or more vehicles under inspection. The disclosure discloses the method and the system for the inspection of the one or more vehicles is done using a wearable interactive device. The disclosure discloses that the wearable interactive device is configured to acquire a unique identifier associated with the one or more vehicles. Further, the wearable interactive device is configured to acquire a set of condition data corresponding to the one or more vehicles by deploying one or more unmanned vehicles. Thereafter, the wearable interactive device is configured to produce a condition report based at least on the acquired set of condition data. Such type of the method does not require any manual operation, and thus results in hands-free operation for the inspection of the one or more vehicles in real time.

Further, the disclosure discloses that the wearable interactive device provides a timestamp of the set of condition data corresponding to the one or more vehicles that may allow the user to quickly view the damage parts of the one or more vehicles. The disclosure further discloses streaming of the condition report live to a first set of users. Thus, such type of the method and the system is reliable, and efficient for the inspection of the one or more vehicles in real time.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various examples of the methods and systems for determining a condition report of one or more vehicles under inspection have been disclosed. However, it should be apparent to those skilled in the art that modifications, in addition to those described, are possible without departing from the inventive concepts herein. The examples, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned examples may be implemented using a wide variety of suitable processes and system modules, and are not limited to any particular computer hardware, software, middleware, firmware, microcode, and the like.

The claims can encompass examples for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for determining a condition report of one or more vehicles under inspection, comprising the steps of:
acquiring a unique identifier associated with a vehicle using a hands-free wearable interactive device, wherein the wearable interactive device is worn by a user for inspecting the vehicle;
acquiring a set of condition data corresponding to the vehicle using the wearable interactive device; and
producing a condition report of the vehicle based at least on the set of condition data acquired using the wearable interactive device.

2. The method of claim 1 further comprising the step of deploying at least one unmanned vehicle in communication with the wearable interactive device for capturing a set of condition data corresponding to the vehicle.

3. The method of claim 2, wherein the at least one unmanned vehicle is selected from the group consisting of: unmanned underwater vehicles, unmanned airborne vehicles, and unmanned ground vehicles.

4. The method of claim 1 further comprising identifying, using the wearable interactive device, the user associated with the inspection of a particular vehicle.

5. The method of claim 1 further comprising transmitting, using the wearable interactive device, the condition report of the vehicle to a remote server in real time.

6. The method of claim 5, wherein the wearable interactive device is configured to retrieve historical data from the remote server, wherein the historical data corresponds to the vehicle being inspected.

7. The method of claim 1, wherein the set of condition data is selected from the group consisting of: still images, video files, and audio recordings corresponding to the vehicle being inspected.

8. The method of claim 7 further comprising providing, using the wearable interactive device, a timestamp of the set of condition data corresponding to the vehicle.

9. The method of claim 1, wherein the wearable interactive device includes a head-mounted display, and a head-mounted camera, and is configured to receive at least one of a user voice command, and a user gesture command.

10. The method of claim 1, wherein the unique identifier is selected from the group consisting of: Vehicle Identification Number; vehicle make; vehicle model; vehicle type; license plate number; lot number, and inventory number.

11. The method of claim 1, wherein the condition report comprises at least one of: a value associated with the vehicle, and identification of damaged parts of the vehicle.

12. The method of claim 1, wherein the vehicle is selected from the group consisting of: cars, trucks, motorcycles, submarines, boats, ships, and aircraft.

13. The method of claim 1 further comprising the step of streaming, using the wearable interactive device, the condition report of the vehicle live to a first set of users.

14. A method for determining a condition report of one or more assets under inspection, comprising the steps of:
acquiring a unique identifier associated with an asset using a hands-free wearable interactive device, wherein the wearable interactive device is worn by a user for inspecting the asset;
acquiring a set of condition data corresponding to the asset using the wearable interactive device; and
producing a condition report of the asset based at least on the set of condition data acquired using the wearable interactive device.

15. The method of claim 14 further comprising deploying, using the wearable interactive device, an unmanned vehicle for capturing the set of condition data corresponding to the asset, wherein the unmanned vehicle is selected from the group consisting of: unmanned underwater vehicles, unmanned airborne vehicles, and unmanned ground vehicles.

16. The method of claim 14 further comprising transmitting, using the wearable interactive device, the condition report of the asset to a remote server.

17. The method of claim 14 further comprising identifying, using the wearable interactive device, the user associated with the inspection of the asset.

18. The method of claim 14, wherein the asset is selected from the group consisting of: buildings, factory equipments, residential structures, civil structures, and mechanical systems.

19. The method of claim 14, wherein the wearable interactive device includes a head-mounted display.

20. A system for determining a condition report of one or more vehicles under inspection, the system comprising:
a wearable interactive device to:
acquire a unique identifier associated with a vehicle, wherein the wearable interactive device is worn by a user for inspecting the vehicle;
acquire a set of condition data corresponding to the vehicle; and
produce a condition report of the vehicle based at least on the set of condition data corresponding to the vehicle.
